(19) United States
(12) Patent Application Publication
(10) Pub. No.: US 2009/0031883 A1
(43) Pub. Date: Feb. 5, 2009

(54) Networked karaoke system and method

(76) Inventor: Christopher Lee Bennetts, Hsin Tien City (TW)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/888,403

(22) Filed: Jul. 31, 2007

(51) Int. Cl. G10H 7/00

(52) U.S. Cl. 84/609

(57) ABSTRACT

A networked karaoke system, comprising an electronic device comprising a karaoke module configured to transmit karaoke content over a communication network for output by at least one other electronic device, the karaoke module configured to receive sing-along content from a user of the at least one other electronic device.

### BACKGROUND

During a group karaoke event, a karaoke device is utilized by multiple participants. For example, the karaoke device is operable to transmit karaoke content to enable a group of participants to sing-along with the karaoke broadcast. However, in such instances, each participant must be in the same location and share microphones in order to sing-along with the transmitted karaoke content.

### BRIEF DESCRIPTION OF THE DRAWINGS

FIG. 1 is a diagram illustrating and embodiment of a networked karaoke system;

FIG. 2 is a block diagram illustrating an embodiment of an electronic device of the networked karaoke system of FIG. 1;

FIG. 3 is a diagram illustrating a display screen of an electronic device of the networked karaoke system of FIG. 1; and

FIG. 4 is a flow diagram illustrating an embodiment of a networked karaoke method.

### DETAILED DESCRIPTION OF THE DRAWINGS

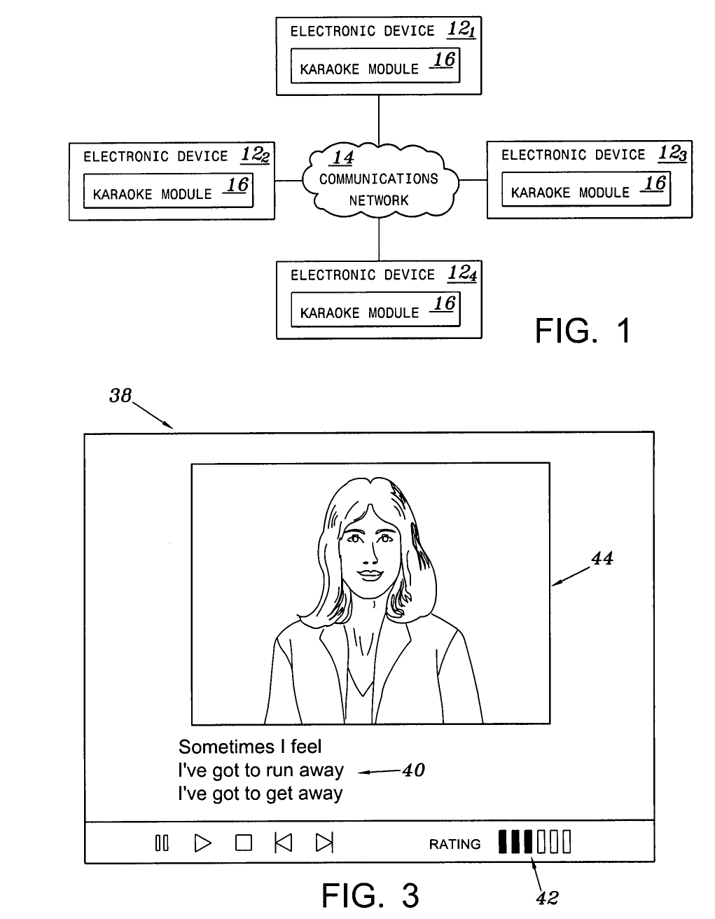

Various embodiments and the advantages thereof are best understood by referring to FIGS. 1-4, like numerals being used for like and corresponding parts of the various drawings.

FIG. 1 is a diagram illustrating an embodiment of a networked karaoke system 10. In the embodiment illustrated in FIG. 1, system 10 comprises a plurality of electronic devices 12₁, 12₂, 12₃ and 12₄ communicatively coupled via a communications network 14 to facilitate a group karaoke event (e.g., multiple karaoke participants singing together and/or otherwise taking part in the event from different, even remote, locations) among users of electronic devices 12₁, 12₂, 12₃ and 12₄. Electronic devices 12₁, 12₂, 12₃ and/or 12₄ may comprise any type of electronic device such as, but not limited to, a notebook or laptop computer, a desktop computer, a dedicated karaoke device, or any other type of portable or non-portable electronic device configured for karaoke. In the embodiment illustrated in FIG. 1, four electronic devices 12₁, 12₂, 12₃ and 12₄ are illustrated; however, it should be understood that a greater or fewer number of electronic devices 12₁, 12₂, 12₃ and/or 12₄ may be used in connection with system 10. According to some embodiments, communications network 14 comprises a local area network; however, it should be understood that communications network 14 may be any type of wired and/or wireless communications network (e.g., the Internet, a cellular network, etc.) that enables communication between electronic devices 12₁, 12₂, 12₃ and 12₄.

In the embodiment illustrated in FIG. 1, each electronic device 12₁, 12₂, 12₃ and 12₄ comprises a karaoke module 16 to facilitate the group karaoke event among electronic devices 12₁, 12₂, 12₃ and 12₄. For example, according to some embodiments, electronic device 12₁ is configured to transmit karaoke content via communications network 14 to at least one other participating electronic device 12₂, 12₃ and/or 12₄. For purposes herein, karaoke content comprises information pertaining to pre-recorded music for transmitting over communications network 14 during a karaoke event. For example, karaoke content comprises audio content containing background music and corresponding video content for displaying lyrics associated with the background music for transmission, for example, by electronic device 12₁ to electronic devices 12₂, 12₃ and/or 12₄. According to some embodiments, when electronic device 12₁ transmits karaoke content, each electronic device 12₁, 12₂, 12₃ and/or 12₄ is configured to receive sing-along audio and/or video content from other electronic devices 12₁, 12₂, 12₃ and/or 12₄ to enable each participant to hear and/or see all karaoke participants at their respective electronic device 12₁, 12₂, 12₃ and 12₄. For purposes herein, sing-along content comprises audio and/or video content from a user of an electronic device 12 in response to receiving karaoke content. Accordingly, users of system 10 can participate in the karaoke event at separate terminals (e.g., a separate electronic device 12₁, 12₂, 12₃ and/or 12₄) to obviate the need of sharing a microphone or other karaoke equipment. Furthermore, electronic devices 12₁, 12₂, 12₃ and 12₄ and respective users may be used at different physical locations (e.g., in different rooms of a house or office, in different cities, etc.). In the above example, electronic device 12₁ is described as the electronic device transmitting karaoke content to other electronic devices 12₁, 12₂, 12₃ and/or 12₄. However, it should be understood that any of electronic devices 12₁, 12₂, 12₃ or 12₄ may transmit karaoke content to other karaoke devices.

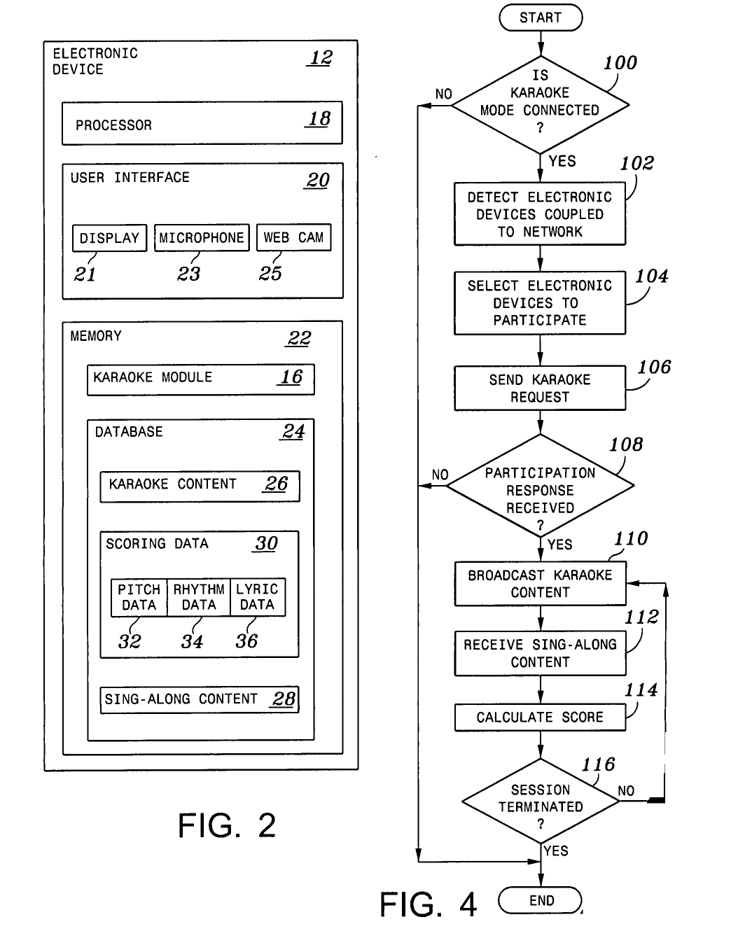

FIG. 2 is a block diagram illustrating an embodiment of an electronic device 12 of karaoke system 10 of FIG. 1 (e.g., representative of all or some of devices 12₁, 12₂, 12₃ and/or 12₄). In the embodiment illustrated in FIG. 2, electronic device 12 comprises a processor 18, a user interface 20 and a memory 22. In FIG. 2, user interface 20 comprises a display screen 21 for displaying information such as, but not limited to, sing-along content and/or karaoke content. User interface 20 also comprises a microphone 23 to record a karaoke participant's voice during the karaoke event and a web cam 25 to capture images of participants during the karaoke event. In FIG. 2, memory 22 comprises karaoke module 16 and a database 24 comprising karaoke content 26, sing-along data 28 and karaoke scoring data 30. In the embodiment illustrated in FIG. 2, karaoke module 16 may comprise hardware, software, firmware, or a combination thereof and is illustrated as being stored in memory 20 so as to be accessible and/or executable by processor 18. However, it should be understood that karaoke module 16 may be otherwise stored, even remotely. Sing along data 28 comprises the sing-along content received from participants/users of other electronic devices 12.

In the embodiment illustrated in FIG. 2, karaoke scoring data 30 comprises information associated with known and/or predetermined signal values that are used to evaluate sing-along data 28 to determine and/or otherwise calculate a karaoke score. For example, in some embodiments, karaoke scoring data 30 comprises, but is not limited to, known and/or predetermined value ranges (e.g., a predetermined value and associated tolerance) corresponding to pitch data 32 (e.g., desired pitch values associated with a particular karaoke song) and rhythm data 34 (e.g., known and/or predetermined value ranges associated with a beat/tempo associated with the karaoke song), and/or lyric data 36 (e.g., known and/or predetermined value ranges associated with lyrics associated with the karaoke song).

In operation, karaoke scoring data 30 is compared against sing-along data 28 to determine how well a participant or group of participants sing with the transmitted karaoke content 26. For example, if sing-along data 28 falls outside the predetermined value range indicated by karaoke scoring data 30 (e.g., if the pitch, beat and/or lyric values are outside a predetermined range), karaoke module 16 of the transmitting electronic device 12₁ adjusts the karaoke score value associated for the particular karaoke event and displays the karaoke score on display members 21 of each electronic device 12₁, 12₂, 12₃ and/or 12₄. In addition, according to some embodiments, if sing-along data 28 falls within a predetermined range within karaoke scoring data 30, karaoke module 16 adjusts the karaoke score accordingly. According to some embodiments, karaoke module 16 of electronic device 12 (e.g., the transmitting electronic device) is configured to calculate a cumulative karaoke score (e.g., a combined score based on all participants/users of electronic devices 12₁, 12₂, 12₃ and/or 12₄), and/or individual karaoke scores (e.g., a respective score for each participant/user of electronic devices 12₁, 12₂, 12₃ and/or 12₄) for output on respective displays 21 of electronic devices 12₁, 12₂, 12₃ and/or 12₄. According to some embodiments, karaoke module 16 of any participating electronic device 12₂, 12₃ and/or 12₄ may be configured to calculate individual and/or cumulative karaoke scores during a karaoke event in addition to or in lieu of karaoke module 16 of electronic device 12₁ for display on respective displays 21. According to some embodiments, karaoke module 16 is configured to transmit the cumulative karaoke score for display on display screen 21 of each electronic device 12₁, 12₂, 12₃ and/or 12₄. Additionally or alternatively, karaoke module 16 may be configured to transmit individual karaoke scores for each participant/user of electronic devices 12₁, 12₂, 12₃ and/or 12₄ for display on each respective display member 20₁ and/or for transmitting to other electronic devices 12₁, 12₂, 12₃ and/or 12₄.

FIG. 3 is a diagram illustrating display screen 38 of electronic device 12 of karaoke system 10 of FIG. 2. In the embodiment illustrated in FIG. 3, display screen 38 is configured to display karaoke music lyrics 40, a karaoke score indicator 42, and a display window 44 to display live video feed or other type of video content from web camera(s) 25 (FIG. 2). In the embodiment illustrated in FIG. 3, karaoke score indicator 42 comprises a bar graph/meter to indicate a score/rating of one or more of the participants, or a cumulative score of the participants, of system 10 calculated by karaoke module 16. However, it should be understood that karaoke score indicator 42 may be otherwise configured (e.g., a numeric, alphanumeric and/or other graphical display) to indicate a score/rating. According to some embodiments, score indicator 42 is automatically and/or dynamically updated via karaoke module 16 to display a karaoke score to users of karaoke system 10. For example, during a karaoke event, score indicator 42 is filled or unfilled with colors or patterns based on the participant(s) performance and/or is updated in real time during participation. With an increased performance score/rating, the color level of score indicator 42 increases (e.g., is fill with colors), and with a decreased performance score/rating, the color level of score indicator 42 decreases (e.g., is unfilled with colors).

FIG. 4 is a flow diagram illustrating an embodiment of a networked karaoke method. The method begins at block 100 where it is determined whether karaoke module 16 of a particular electronic device 12 (e.g., 12₁) is enabled in a karaoke mode (e.g., whether karaoke module 16 is configured to transmit karaoke content 26 (FIG. 2) to other electronic devices 12 on communications network 14). In the event karaoke module 16 is configured in the karaoke mode, the method proceeds to block 102 where karaoke module 16 searches for other electronic devices 12 (e.g., 12₂, 12₃ and/or 12₄) communicatively coupled to communications network 14. For example, in some embodiments, karaoke module 16 is configured to perform an enumeration process to detect electronic device 12₂, 12₃ and/or 12₄ communicatively coupled via communications network 14. Karaoke module 16 provides and/or otherwise displays to a user of transmitting electronic device 12₁ a list of the detected electronic devices 12₂, 12₃ and/or 12₄ to enable the user of electronic device 12₁ to select electronic device 12₂, 12₃ and/or 12₄ to be included in the karaoke event. The method proceeds to block 104 where karaoke module 16 of electronic device 12₁ is utilized to select one or more discovered electronic devices 12 (e.g., electronic device 12₂, 12₃ and/or 12₄) to participate in the karaoke event. For example, in some embodiments, karaoke module 16 is configured to perform an enumeration process to detect electronic device 12₂, 12₃ and/or 12₄ communicatively coupled via communications network 14. Karaoke module 16 provides and/or otherwise displays to a user of transmitting electronic device 12₁ a list of the detected electronic devices 12₂, 12₃ and/or 12₄ to enable the user of electronic device 12₁ to select electronic device 12₂, 12₃ and/or 12₄ to be included in the karaoke event.

The method proceeds to block 106 where karaoke module 16 sends a karaoke request and/or invite to the selected electronic device 12₂, 12₃ and/or 12₄ requesting participation in the group karaoke event (e.g., a request to transmit karaoke content 26 to the at least one other electronic device 12₂, 12₃ and/or 12₄). For example, after the user of electronic device 12₁ selects one or more of electronic devices 12₂, 12₃ and/or 12₄ for participation, karaoke module 16 sends a karaoke request/invite to electronic devices 12₂, 12₃ and/or 12₄ to transmit karaoke content 26 to enable participation in the karaoke event. If at decisional block 108 karaoke module 16 receives a participation response from any of the invited electronic devices 12₂, 12₃ and/or 12₄ (e.g., an acceptance to participate in the karaoke event by a respective user of electronic device 12₂, 12₃ and/or 12₄), the method proceeds to block 110, where karaoke module 16 of electronic device 12₁ transmits karaoke content 26 to all participating electronic devices 12₂, 12₃ and/or 12₄.

According to some embodiments, transmitting electronic device 12₁ receives sing-along content from each participating electronic device 12₂, 12₃ and/or 12₄ as indicated in block 112 and may store as sing-along data 28 in database 24 for later playback and/or scoring analysis. For example, according to some embodiments, karaoke module 16 of electronic device 12₁ receives sing-along content from each participating electronic device 12₂, 12₃ and/or 12₄ for scoring and transmits the calculated scores (e.g., a cumulative score for all participants and/or an individual score for each participant) to each electronic device 12₂, 12₃ and/or 12₄ for display thereon, as indicated at block 114. However, it should be understood that system 10 may be otherwise configured. For example, according to some embodiments, karaoke module 16 of each electronic device 12₁, 12₂, 12₃ and/or 12₄ calculates a respective individual karaoke score for a user of the respective electronic device 12₁, 12₂, 12₃ and/or 12₄ and transmits the calculated karaoke to the other electronic device(s) 12₁, 12₂, 12₃ and/or 12₄ for viewing and/or calculating a cumulative karaoke score by each electronic device 12₁, 12₂, 12₃ and/or 12₄. According to another embodiment, karaoke module 16 of each electronic device 12₁, 12₂, 12₃ and/or 12₄ calculates an individual karaoke score for the user(s) of the respective electronic device 12₁, 12₂, 12₃ and/or 12₄ and transmits the calculated individual karaoke score to transmitting electronic device 12₁ to enable karaoke module 16 of electronic device 12₁ to calculate a cumulative karaoke score. In operation, after calculating the cumulative karaoke score, karaoke module 16 transmits the cumulative karaoke score to each participating electronic device 12₂, 12₃ and/or 12₄ for display thereon. According to yet another embodiment, karaoke module 16 of each electronic device 12₁, 12₂, 12₃ and/or 12₄ calculates a respective karaoke score and further, receives and analyzes sing-along content from the other electronic devices 12₁, 12₂, 12₃ and/or 12₄ to generate a cumulative karaoke score.

The method proceeds to block 116 where it is determined whether or not transmitting electronic device 12₁ has terminated the karaoke broadcast. If at decisional block 116 transmitting electronic device 12₁ has terminated the broadcast, the method ends. In the event the transmitting electronic device 12₁ has not terminated the broadcast, the method returns to block 110. It should be understood that at anytime during the karaoke event, a participating electronic device 12₂, 12₃ and/or 12₄ may terminate its participation in the karaoke event via an input command to its respective karaoke module 16.

Thus, embodiments of system 10 enable transmitting of a karaoke song via a transmitting electronic device 12₁ over communications network 14 to a plurality of participant electronic devices 12₂, 12₃ and/or 12₄. It should be understood that in the described method, certain functions may be omitted, accomplished in a sequence different from that depicted in FIG. 4, or simultaneously performed. Also, it should be understood that the method depicted in FIG. 4 may be altered to encompass any other features or aspects as described elsewhere in the specification. Furthermore, embodiments may be implemented in software and can be adapted to run on different platforms and operating systems. In particular, functions implemented by karaoke module 16, for example, may be provided as an ordered listing of executable instructions that can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this document, a computer-readable medium can be any means that can contain, store, communicate, propagate or transport the program for use by or in connection with the instruction execution system, apparatus or device. The computer-readable medium can be, for example but is not limited to, an electronic, magnetic, optical, electromagnetic, infrared, or semiconductor system, apparatus, device or propagation medium.

What is claimed is:

1. A networked karaoke system, comprising:
an electronic device comprising a karaoke module configured to transmit karaoke content over a communication network for output by at least one other electronic device, the karaoke module configured to receive sing-along content from a user of the at least one other electronic device.

2. The system of claim 1, wherein the karaoke module is configured to send an invite to the at least one other electronic device to participate in a group karaoke event.

3. The system of claim 1, wherein the karaoke module is configured to transmit karaoke content to the at least one other electronic device in response to receiving a participation response from the at least one other electronic device.

4. The system of claim 1, wherein the karaoke module is configured to transmit karaoke content to the at least one other electronic device via a local area network.

5. The system of claim 1, wherein the karaoke module is configured to detect the presence of the at least one other electronic device on the communication network.

6. The system of claim 1, wherein the sing-along content comprises video content received from the at least one other electronic device.

7. The system of claim 1, wherein the sing-along content comprises audio content received from the at least one other electronic device.

8. The system of claim 1, wherein the karaoke module is configured to transmit sing-along content to the at least one other electronic device.

9. A networked karaoke method, comprising:
transmitting karaoke content over a communication network for output by at least one other electronic device; and
receiving, by the karaoke module, sing-along content from a user of the at least one other electronic device.

10. The method of claim 9, further comprising sending an invitation to the at least one other electronic device to participate in a group karaoke event.

11. The method of claim 9, further comprising transmitting the karaoke content to the at least one other electronic device in response to receiving a participation response from the at one least one other electronic device.

12. The method of claim 9, further comprising transmitting karaoke content to the at least one other electronic device via a local area network.

13. The method of claim 9, further comprising receiving audio content from the at least one other electronic device.

14. The method of claim 9, further comprising receiving video content from the at least one other electronic device.

15. The method of claim 9, further comprising transmitting sing-along audio content to the at least one other electronic device.

16. The method of claim 9, further comprising detecting the presence of the at least one other electronic device on the communication network.

17. A computer-readable medium having stored thereon an instruction set to be executed, the instruction set, when executed by a processor, causes the processor to:
transmit karaoke content over a communication network for output by at least one electronic device; and
receive sing-along content from a user of the at least one electronic device.

18. The computer-readable medium of claim 17, wherein the instruction set, when executed by a processor, causes the processor to send an invite to the at least one electronic device to participate in a group karaoke event.

19. The computer-readable medium of claim 17 wherein the instruction set, when executed by a processor, causes the processor to transmit karaoke content to the at least one other electronic device in response to receiving a participation response from the at least one electronic device.

20. The computer-readable medium of claim 17 wherein the instruction set, when executed by a processor, causes the processor to detect the presence of the at least one electronic device on the communication network.
